(19) United States
(12) Patent Application Publication
(10) Pub. No.: US 2018/0144521 A1
(43) Pub. Date: May 24, 2018

(54) Geometric Work Scheduling of Irregularly Shaped Work Items

(71) Applicant: QUALCOMM Incorporated, San Diego, CA (US)

(72) Inventors: Hui Chao, San Jose, CA (US); Tushar Kumar, San Francisco, CA (US); Wenjia Ruan, Santa Clara, CA (US); Arun Raman, San Francisco, CA (US)

(21) Appl. No.: 15/358,515

(22) Filed: Nov. 22, 2016

(51) Int. Cl. G06T 11/60; G06T 5/50

(52) U.S. Cl. CPC G06T 11/60; G06T 2207/10004; G06T 5/50

(57) ABSTRACT

Various embodiments may include methods executed by processors of computing devices for geometry based work execution prioritization of irregular shapes on a computing device. Various embodiments may include calculating cost functions for an irregularly shaped work region detected by the computing device. The processor may map the irregularly shaped work region to a geometrically-bounded first work region within an N-dimensional space. The processor may then assess the efficacy of implementing modification strategies such as merging work regions or splitting a large work region into sections. Two or more smaller work regions may be merged to create a larger work region that may be more easily processed by a processing unit. Similarly, large shapes may be split into multiple smaller regularly shaped work regions that may be processed by different processors.

### BACKGROUND

The use of mobile device cameras to capture images and record video content continues to grow as a greater number of applications make use of or allow users to share multimedia content. There are also many applications of image generation (e.g., video games, augmented reality, etc.) that place significant demands on computer processing resources. Two examples are stitching together image frames while a user pans a cell phone to generate a panoramic image, and virtual reality imaging. Both techniques require the processing of multiple, sometimes numerous, images in order to generate a single image product. Virtual reality imaging requires the such processing techniques to be repeated several time per second. Methods of efficiently processing or pre-processing image data (captured or rendered) are desirable to reduce the processing power required to perform rapid image processing and reduce visual lag. This is particularly the case for mobile devices, such as smart phones, which may have limited processing and stored power resources.

### SUMMARY

Various embodiments may include methods executed by processors of computing devices for geometry based work execution prioritization of irregularly shaped shapes on a computing device. Various embodiments may include calculating a cost function for a work region, implementing a splitting strategy on the work region to break the work region into a plurality of work region sections, implementing a merging strategy on the plurality of work region sections, determining whether the cost function can be reduced by splitting and merging the work region sections, and processing the split and merged work region sections in response to determining that the cost function can to be reduced.

In some embodiments, implementing a splitting strategy on the work regions to break the work region into a plurality of work region sections may include identifying sections of the work region, estimating a divided resource cost of the work region based on processing the identified sections, determining whether the cost function for the work region is greater than the divided resource cost, and splitting the identified sections from the work region to the plurality of produce work region sections in response to determining that the cost function for the work region is greater than the divided resource cost. In such embodiments, estimating a divided resource cost of the work region based on processing the identified sections may include calculating a splitting cost function for a work region section that would result from splitting an identified section away from the work region, and estimating the divided resource cost of all of the cost functions associated with the work region including the split cost function. In such embodiments, implementing a splitting strategy on the work regions to break the work region into a plurality of work region sections may be repeated on the plurality of work region sections until there are no remaining sections for which the resulting divided resource cost is less than an undivided resource cost.

In some embodiments, implementing a merging strategy on the plurality of work region sections may include calculating an unmerged resource cost based, at least in part, on cost functions of processing all of the plurality of work region sections without merging, identifying multiple work region sections for merger, estimating a merged resource cost of all of the work region sections, determining whether the unmerged resource cost is greater than the merged resource cost, and merging the identified work region sections in response to determine that the unmerged resource cost is greater than the merged resource cost. In such embodiments, estimating the merged resource cost of all of the work region sections may include calculating a merger cost function for a potential work region that would result from the merger of the identified work region sections, and estimating the merged resource cost of all of the cost functions including the merged cost function. In such embodiments, implementing a merging strategy on the plurality of work region sections may be repeated until there are no remaining potential work region section mergers for which the resulting merged resource cost is less than the unmerged resource cost.

In some embodiments, the work regions are viewports of a virtual reality view space. In some embodiments, the work regions are image frames to be combined into a panorama image.

In such embodiments, processing the split and merged work region sections may include assigning the work region sections to different processing units based, at least in part, on characteristics of the work regions, and processing each of the work region sections on the assigned processing unit.

Further embodiments include a computing device having memory coupled to a processor that configure is configured to perform operations of the embodiment methods summarized above. Further embodiments include non-transitory processor-readable media on which are stored processor-executable instructions configured to cause a processor perform operations of the embodiment methods summarized above.

### BRIEF DESCRIPTION OF THE DRAWINGS

The accompanying drawings, which are incorporated herein and constitute part of this specification, illustrate exemplary embodiments of the methods and devices. Together with the general description given above and the detailed description given below, the drawings serve to explain features of the methods and devices, and not to limit the disclosed embodiments.

FIG. 1 is a block diagram illustrating a computing device suitable for use with various embodiments.

FIG. 2 is a block diagram illustrating a communications device according to various embodiments.

FIG. 3A is an illustration of an image generation situation that results in irregularly shaped composite images.

FIG. 3B is a diagram illustrating the mapping of detected events to a three dimensional space according to various embodiments.

FIG. 4 is a diagram illustrating exemplary distribution of sections of an irregularly shaped work region to different processing units.

FIG. 5 is a diagram illustrating methods for merging work regions according to the various embodiments.

FIG. 6 is a diagram illustrating methods of splitting work regions into sections according to various embodiments.

FIG. 7 is a functional block diagram illustrating workflow in a geometrically based work prioritization method according to various embodiments.

FIG. 8 is a process flow diagram illustrating a method for geometrically based prioritization of work processing according to various embodiments.

FIG. 9 is a process flow diagram illustrating a method for merging work regions in a geometric work scheduling process according to various embodiments.

FIG. 10 is a process flow diagram illustrating a method for splitting work regions in a geometric work scheduling process according to various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the claims.

Various embodiments provide methods for organizing the processing of work regions to improve processing efficiency. Various embodiments may be of particular benefit in the processing of images and the generation of images for display on a computing device.

The terms “computing device” is used herein to refer to any one or all of a variety of computers and computing devices, digital cameras, digital video recording devices, non-limiting examples of which include smart devices, wearable smart devices, desktop computers, workstations, servers, cellular telephones, smart phones, wearable computing devices, personal or mobile multi-media players, personal data assistants (PDAs), laptop computers, tablet computers, smart books, palm-top computers, wireless electronic mail receivers, multimedia Internet enabled cellular telephones, wireless gaming controllers, mobile robots, and similar personal electronic devices that include a programmable processor and memory.

The term “geometrically bounded regions” is used herein to refer to any spatial mapping within an N-dimensional space. Geometrically bounded regions may include executable work items mapped to “work regions”. Sub regions of geometrically-bounded regions may be any portion lying within the boundaries of a geometrically-bounded region. Such sub regions may be referred to as “sections” of a work region.

The term “panorama” is used herein to refer to any composite image or video that is generated through the combination (e.g., stitching) of multiple image or video files. Image and video files may be captured by a computing device camera, scanning device or other image and video capture device in communication with the computing device. Portions of each image or video may be stitched to other images or videos to produce an extended image having larger dimensions than the original component images. Panoramas may include images or videos having extended axial dimension.

Resource intensive processing tasks such as image processing in rapid motion, virtual reality, or video game applicants, may consume significant processing resources and consequently may contribute to increased battery consumption. Inefficient processing of image and application data in such applications may lead to undesirable visual effects, such as movement lag, jittering, disappearing objects, and unnatural object movements. Further degrading the user experience is the fact that such visual effects are known to induce nausea and vertigo in some users. Reducing the processing time of images and application data through more efficient processing techniques may reduce the frequency and degree of such undesirable visual effects. However, it may be difficult to determine universally efficient hardware-independent methods for processing images and application data in resource intensive applications because hardware profiles differ dramatically across computing devices.

Various embodiments enable more efficient processing of resource intensive tasks by computing devices by analyzing tasks for common elements appropriate for processing by specific processing units. By scheduling tasks for processing based on the attributes or characteristics of work items that fit local hardware profiles in the manner addressed in the claims, the various embodiments may enable fast, efficient processing of tasks by computing devices. This may in turn reduce strain on one or more processing units of computing devices and, by reducing processing workload, may reduce battery power consumption. Improving the processing efficiency of computing devices performing resource intensive tasks may also improve user experience by reducing the visual jitter, shake, and lag that results from extended processing times.

In overview, the various embodiments and implementations may include methods, computing devices implementing such methods, and non-transitory processor-readable media storing processor-executable instructions implementing such methods for geometry based work execution prioritization of irregularly shaped shapes on a computing device. Various implementations may include a processor calculating cost functions for an irregularly shaped work region for processing by the computing device. The processor may map the irregularly shaped work region to a geometrically-bounded first work region within an N-dimensional space. The processor may then assess the efficacy of implementing strategies for modifying the first work region to improve processing efficiencies. Examples of modification strategies may include merging two or more work regions into a larger work region and splitting a large work region into two or more smaller work regions or sections. Thus, two or more small work regions may be merged to create a larger work region that may be more easily processed by a processing unit. Similarly, large shapes, particularly those with an irregular shape, may be split into multiple smaller regularly shaped work regions that may be processed by different processors more or less in parallel.

The scheduling of work items for processing in a heterogeneous environment is resource and device dependent. The efficient load balancing and distribution may require the knowledge the performance of each work item on difference computing units, e.g. GPU, CPU or DSP. The performance gain or loss from processing a specific type of work item on each processing unit may depends on multiple features. One such feature is data movement/memory access, such as memory overhead (e.g. need to copy data from CPU to GPU or DSP memory), the regularity of memory access patterns, and the size of the memory. Other features affecting performance may be the amount of computing performed for each memory access, and model/type of GPU, CPU, and DSP.

Different computing devices may have differing hardware profiles, which may impact performance characteristics. Hardware profiles and configurations may impact the amount of overhead needed to launch work items. For example, the GPU and DSP may have high resource overhead, making those processors unsuitable for processing numerous small work items. However, depending on the nature of the work, the GPU and DSP processors may be power efficient (i.e., low resource consumers). Thus, power stored in a device battery may be conserved by processing substantially sized work items with the GPU rather than the CPU big cores, which may in turn be more efficient than the CPU little cores. The DSP may be more efficient than the GPU or less so depending on the nature of the work item being processed.

The shape of a work region, and its respective mapping into an N-dimensional space to produce a processing work item, may have an impact on processor performance. Irregularly shaped objects lead to lower utilization in processing work because the processing unit must attempt to process the “padding” or empty spots in a shape before realizing that there is no real work in the region. This may slow down the processing of work items associated with irregularly shapes. In software applications that require significant image processing, the slowed processing time can lead to visual effects such as lag, jitter, or jumping of on-screen elements. If these effects are too significant, the effects may negatively affect the user experience, and may lead to motion sickness or vertigo. These effects may be mitigated through techniques for efficiently processing irregularly shaped work items to reduce undesirable visual effects.

Irregularly shaped work items may impact some or all of: memory continuity, transfer efficiency (memcpy or memory copy), and access efficiency (caching); processing unit efficiency (i.e., CPU good at random access while GPU may be best suited to regular shapes); and the amount of computation needed to complete processing of a work item (e.g., CPU: small launch overhead, small computation ok). Various embodiments may include training a device specific performance model so as to learn or estimate the changes in performance attributable to the above features.

In various embodiments, the computing device may use the performance model to calculate a cost function or performance modifier for each work region. The cost function may represent the processing cost of processing the work item associated with the work region on a given processing unit. The cost function may also be considered a measure of a work region's suitability for processing on a particular processing unit (e.g., a work score). For example, the cost function or performance modifier may account for:
a. Launch overhead: small work-item→suitable to CPU; large work item→GPU or DSP;
b. Battery/Power consumption: bias score up for GPU/DSP, bias score down for CPU;
c. Cancelling work: Larger likelihood of cancellation→suitable for CPU, small likelihood of cancellation→suitable for GPU/DSP; and
d. Utilization: the degree of regularity (e.g., rectangular) in shape: High→bias score up for GPU;

The cost function or resulting performance modifier may be a combination of the above factors, e.g., a weighted sum of factors. For this reason, the cost function may take into account such characteristics as memory size and type (GPU: texture buffer, cl buffer, ION mapped to texture; ION mapped to cl buffer; CPU: regular buffer, ION buffer; DSP: regular buffer, ION buffer); memory access in different irregular patterns (continuously; every other pixel, every 3 pixels; every r pixel, where r is a random number within a range); number of memory access per pixel and type; number of fixed point operations; and the number of floating point operation. In some embodiments, the cost function may be invalid to indicate that no possibility of executing on a given processing unit. In various embodiments, the cost function and resulting performance modifier may be construed as a “work score.”

Various embodiments may enable organizing or grouping the processing of data sets such as images based on identified irregularly shaped geometrically bounded regions within each data set. Various embodiments may include scheduling work across processing units of a computing device based on irregularly shaped geometrically bounded regions identified as having similar elements and thus similar cost functions.

For example, during active image capture sessions, a computing device may identify geometric regions of a captured image, and associate work with each region. The computing device may identify geometrically bounded regions within irregularly shaped images or other data work items. As images are received, the computing device may determine whether the image has a regular (e.g., standard shape such as rectangular or circular) or irregular shape. For irregularly shaped images, the computing device may apply slicing techniques to divide the shape into multiple rectangular regions that can processed more efficiently. The computing device may attempt multiple slicing techniques in order to cover the most area of the irregularly shaped image. For example, the computing device may detect a large rectangular region within an image to be processed/generated, and then begin vertically and horizontally slicing the remaining portions of the image to obtain smaller and smaller regularly shaped regions.

While or after dividing an image into regularly shaped portions, the computing device may perform a cost estimate to determine the resource costs of processing all of the identified work regions individually. As mentioned above, the cost function determination takes several computing device characteristics into account. The computing device may learn the cost function for each captured image or incoming work item. Optionally, the computing device may mask or remove unwanted pixels from the image prior to determining the cost function in order to reduce resource cost.

In addition to or in lieu of splitting work regions, the computing device may determine a merging strategy in which the work regions may be merged to group for processing image regions (or data sets) having similar characteristics. Merging strategies may include clustering based on the proximity of work regions within an image or work item. There may be different ways to compute the best merging or grouping strategy, such as k-means, or a bottom-up agglomerative clustering in which each work item starts in its own cluster and pairs of clusters are merged as one moves up the hierarchy. For example, the computing device may select the two geometrically bounded regions with the smallest discontinuity in characteristics and merge those regions. The computing device may determine a cost function for the merged work regions. If the cost function for the merged regions is lower than the overall cost function prior to merging, then the merged region may remain, otherwise the two regions may be left unmerged. The computing device may continue this process in an iterative manner until all geometric regions of a similar type are clustered or merged.

Any merged or preexisting geometric regions for which the cost function is higher than the overall cost function may be split into two or more regions. Like the merging strategy, the computing device may continue determining cost functions and splitting regions until all regions have a cost function smaller than that of the overall cost function for processing the original shape. The remaining geometric regions may be queued as work items in the processing queues of different computing device processors, based on the characteristics of each geometric region. Thus, the various embodiments may use geometric region identification in irregularly shaped captured images (e.g., stitching panorama) or frames being rendered (e.g., virtual reality displays) to determine an efficient way to schedule/prioritize work processing accordingly for captured images and software applications. Such techniques may reduce processing time or power for irregularly shaped work items, and thus may reduce visual lag, jitter, and jumping in image processing applications, video games, and virtual reality applications and preventing device overheating or battery over consumption.

In various embodiments, a computing device may divide the workload of an application across one or more processors. The work may be separated and scheduled to increase processing efficiency and reduce power consumption needed in order to generate a final product or perform application operations.

Various embodiments may enable the computing device to prioritize the processing of geometric regions of captured/rendered images based on shared characteristics of the geometric regions. Various embodiments may enable the computing device to partition irregularly shaped images into geometric regions and grouping regions for work processing. Various embodiments may enable the computing device to group geometrically bounded regions of a captured image for processing based on the resource cost of processing each region. Various embodiments may enable the computing device to divide geometrically bounded regions of a captured image into smaller processing units based on the resource cost of the geometrically bounded regions.

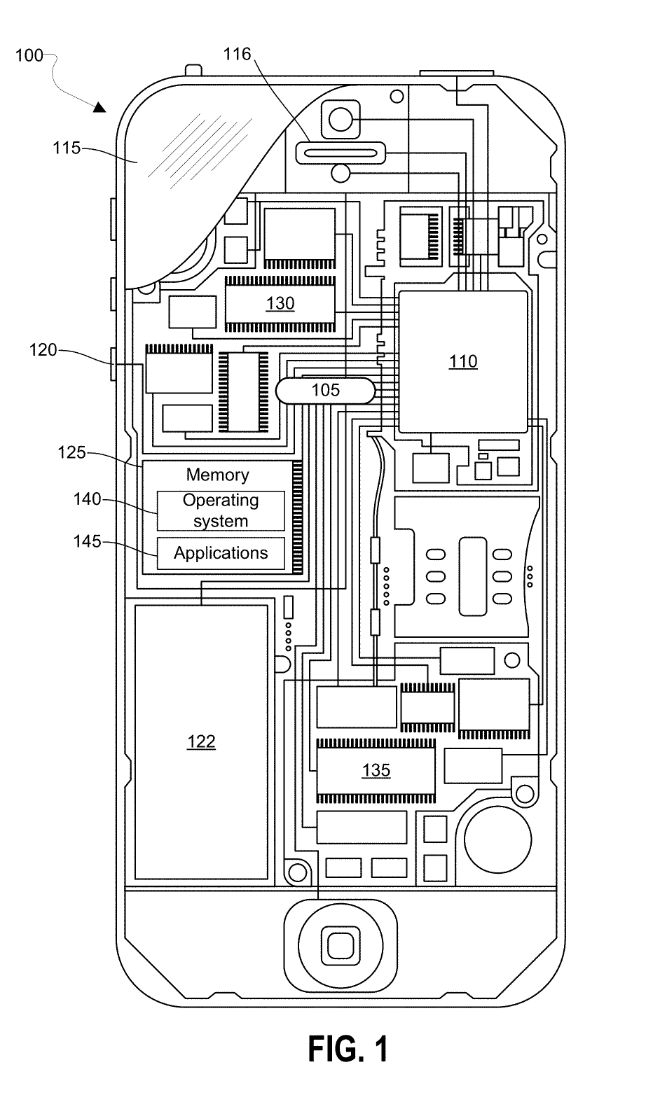

FIG. 1 illustrates a computing device 100 suitable for use with various embodiments. The computing device 100 is shown comprising hardware elements that can be electrically coupled via a bus 105 (or may otherwise be in communication, as appropriate). The hardware elements may include one or more processor(s) 110, including without limitation one or more general-purpose processors and/or one or more special-purpose processors (such as digital signal processing chips, graphics acceleration processors, and/or the like); one or more input devices, which include a touchscreen 115, and further include without limitation one or more cameras, one or more digital video recorders, a mouse, a keyboard, a keypad, a microphone and/or the like; and one or more output devices, which include without limitation an interface 120 (e.g., a universal serial bus (USB)) for coupling to external output devices, a display device, a speaker 116, a printer, and/or the like.

The computing device 100 may further include (and/or be in communication with) one or more non-transitory storage devices such as non-volatile memory 125, which can include, without limitation, local and/or network accessible storage, and/or can include, without limitation, a disk drive, a drive array, an optical storage device, solid-state storage device such as a random access memory (RAM) and/or a read-only memory (ROM), which can be programmable, flash-updateable, and/or the like. Such storage devices may be configured to implement any appropriate data stores, including without limitation, various file systems, database structures, and/or the like.

The computing device 100 may also include a communications subsystem 130, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other devices, and/or any other devices described herein. The computing device (e.g., 100) may further include a volatile memory 135, which may include a RAM or ROM device as described above. The memory 135 may store processor-executable-instructions in the form of an operating system 140 and application software (applications) 145, as well as data supporting the execution of the operating system 140 and applications 145. The computing device 100 may be a mobile computing device or a non-mobile computing device, and may have wireless and/or wired network connections.

The computing device 100 may include a power source 122 coupled to the processor 110, such as a disposable or rechargeable battery. The rechargeable battery may also be coupled to the peripheral device connection port to receive a charging current from a source external to the computing device 100.

The computing device 100 may include various external condition sensors such as an accelerometer, a barometer, a thermometer, and the like. Such external sensors may be used by the computing device 100 to provide information that may be used in the determination as to whether and how obtained images and video are changing from image to image or video to video.

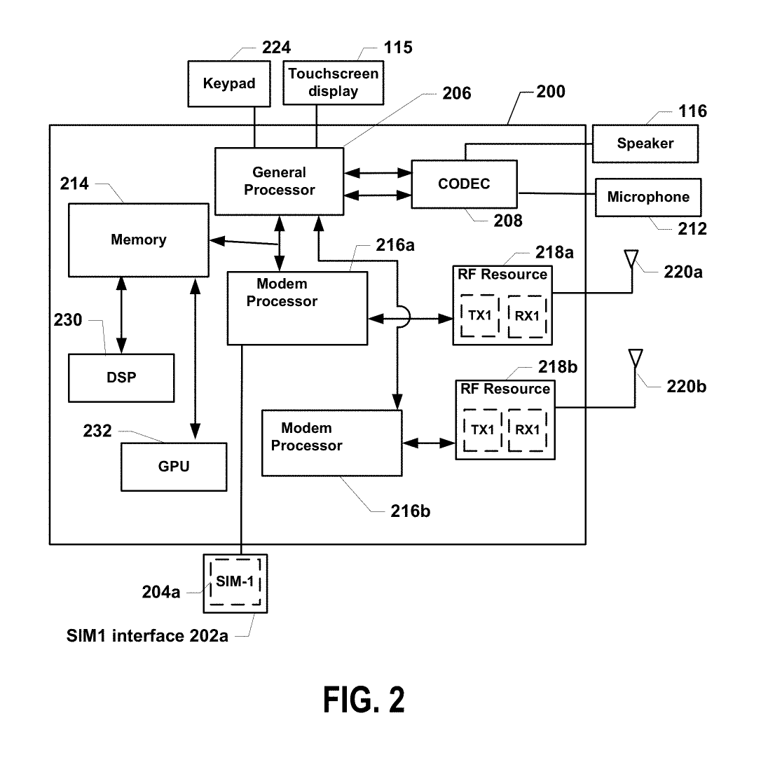

Various embodiments may be implemented within a system-on-chip for use within a computing device. An example system-on-chip 200) suitable for implementing various embodiments is illustrated in FIG. 2. With reference to FIGS. 1 and 2, the system-on-chip 200 may include at least one controller, such as a general processor 206 (e.g., processing unit 110), which may be coupled to a coder/decoder (CODEC) 208. The CODEC 208 may in turn be coupled to input/output leads that may be coupled to a speaker 116 and a microphone 212 when implemented in a computing device. The general processor 206 may also be coupled to the memory 214 (e.g., non-transitory storage 125 and/or volatile storage 135) that may reside on the system-on-chip 100. The memory 214 may store an operating system (OS), as well as user application software and executable instructions. The memory 214 may also store application data, such as an array data structure. The system-on-chip 200 may also include input/output leads (not shown) for connecting to other memory within a computing device on which may be stored application software and application data.

A system-on-chip 200 may also include a digital signal processor (DSP) 230 and a graphical processing unit (GPU) 232. Each of the DSP and GPU may be coupled to the memory 214 and may include respective intervening caches.

The general processor 206, the DSP 230, the GPU 232, and the memory 214 may be coupled one or more modem processors 216a and 216b and radio frequency (RF) resources 218a, 218b, which may also be included on a system-on-chip 100. The RF resources 218a, 218b may be coupled to RF interfaces for connecting with antennas 220a, 220b.

A system-on-chip 200 may include an input/output interface for connecting to one or more subscriber identity module (SIM) interfaces 202a, 202b, which may receive SIM cards 204a, 204b. For example, a SIM may be a Universal Integrated Circuit Card (UICC) configured to enable access to GSM and/or UMTS networks, or a UICC removable user identity module (R-UIM) or a Code Division Multiple Access (CDMA) subscriber identity module (CSIM) configured to enable access to a CDMA network.

In Further, various input and output devices may be coupled to components on the system-on-chip 200, such as interfaces or controllers. For example, a system-on-chip 100 may include input/output leads for connecting to a keypad 224 and/or a touchscreen display 115.

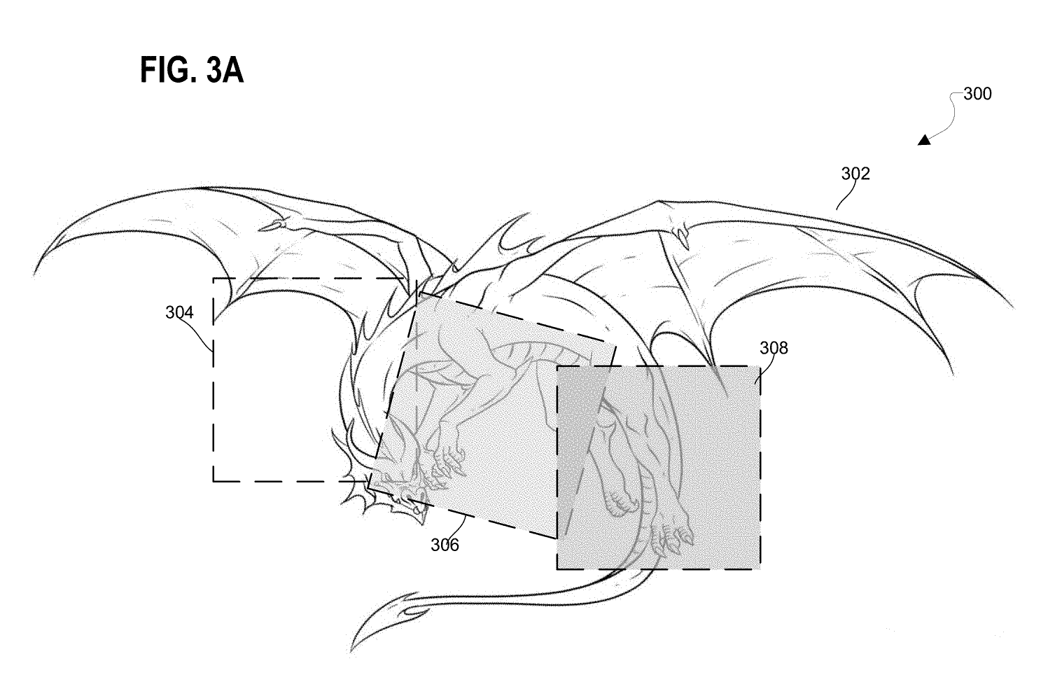

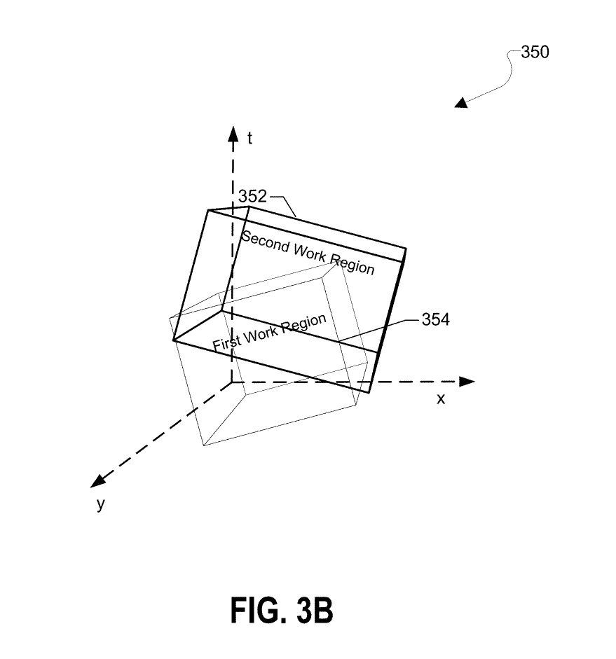

FIG. 3A illustrates regions of an image 300 to be generated for a virtual reality rendering of a video game image. Virtual reality systems may include tracking the direction or motion of a display system (e.g., stereoscopic displays) based on movement of the user's head as well as movement of an object 302 within the virtual space. Based upon the calculated field of view to be presented on the display system and movement of the object 302 within the virtual space, a processor (e.g., 110) of a computing device (e.g., 100) may determine image frames 304, 306, 308 to be rendered. As the field of view of the display system shifts and the object 302 moves across portions of a virtual reality scene 302, the elements illustrated within obtained image frames 304-308 may shift with respect to each other.

In various implementations, as each new image frame 304-308 is scheduled for generation, a working boundary shape (e.g., bounding box) defining the common shared dimensions of the image frames may be modified (i.e., updated). As the display system field of view pivots and moves in a horizontal direction, the perimeter of the working boundary shape may also move and tilt, cutting out regions positioned above the upper edge of the highest image (e.g., image frame 304). Similarly, as image frame 308 is generated, the lower boundary of the working boundary shape may be raised to the lower edge of the lowest image frame (e.g., image frame 308).

FIG. 3B illustrates an example of an event mapping 350 in an N-dimensional space. In the illustrated event mapping 350, a computing device (e.g. computing device (e.g., 100)) has mapped a first event to a first work region 352 based on a characteristic triple including a horizontal (e.g., x), vertical (e.g., y), and temporal (e.g., t) coordinate. The first work region 35 has a rectangular shape defined by the lightweight line boundaries. A second work region 354 may lie in a region of the N-dimensional space that partially overlaps the first work region 352. All portions of the first work region 352 lying within the default boundary region will be included in an initialized working boundary region, which may be compared to subsequent work regions. The portion of the first work region 352 that overlaps with the second work region 354 may be irregular in shape. The irregular shape may result from skewed boundary intersections between the surface areas of two work regions.

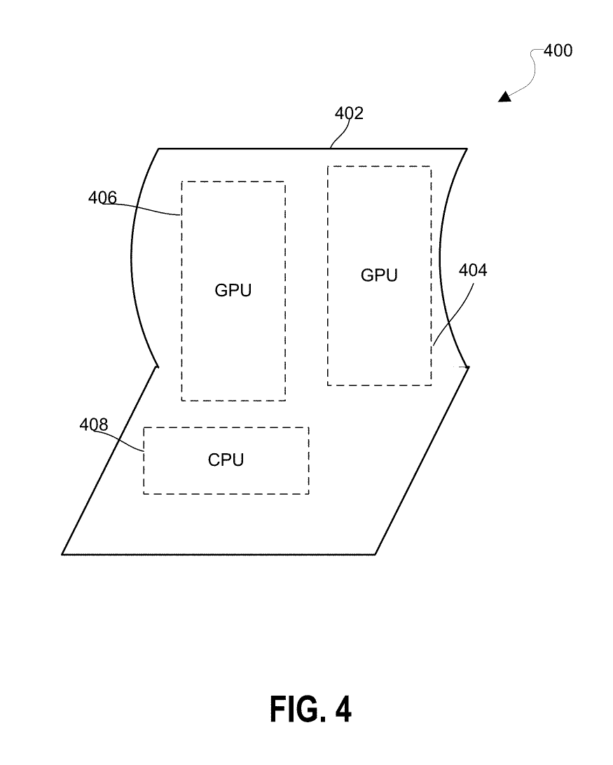

FIG. 4 illustrates a block diagram 400 of division of sections of an irregularly shaped work region for processing by different processing units according to various embodiments and implementations. Various implementations may include assigning sections of a work region by the processor (e.g., 110) of a computing device (e.g., 100) to different processors of the computing device based on characteristics of the sections.

Various embodiments may include merging work regions into new work regions or splitting off sections of existing work regions in order to obtain processing work items suited to individual processing units. For example, in the irregularly shaped region 402, which may have been merged from two other work regions, there may be multiple sections. For example, sections 404 and 406 may have a shape, size, orientation, and/or content that is best suited for processing on the GPU, while section 408 may have a shape, size, orientation, and/or content that is best suited to processing by the CPU.

Various embodiments may include different shape modification techniques given the performance model for processing units of the computing device and the original shape of a work region. The various embodiments may perform initial cost function estimates for working directly with an unmodified irregularly shaped work region. The computing device may slice out the largest enclosed rectangular work region and send that work region to the GPU or DSP for processing and send the remaining irregular edges to CPU for processing. The computing device may engage in both horizontal and vertical slicing in order to obtain the most large rectangular regions.

The computing device may implement a model to determine a cost function associated with each of the sections, and thus determine the best processing unit for a particular work region. The model may be trained using linear regression and may account for processing unit features such as: the size of memory, the type of memory the regularity of memory access, (e.g. continuously, every k-th pixel or random access); and the number of operations per memory access. Thus, the splitting and merging strategies may be modified for each new work region obtained by the computing device in order to account for different types of desired performance. Performance targets may be set, such as lowest power, fastest speed, lowest latency, or highest throughput. The computing device may select the best splitting, merging and processing (on GPU, CPU, or DSP) strategy based on the performance targets as defined by the cost functions.

The computing device may execute a set of pre-designed benchmarks to learn such cost functions. Such benchmarks may be associated with a number of features, such as: memory size and type (GPU: texture buffer, cl buffer, ION mapped to texture; ION mapped to cl buffer; CPU: regular buffer, ION buffer; DSP: regular buffer, ION buffer); memory access in different irregular patterns (continuously; every other pixel, every 3 pixels; every r pixel, where r is a random number within a range); number of memory access per pixel and type; number of fixed point operations; and the number of floating point operation. As an example, the cost function for each work region may be represented by the function:

Cost=Σ₀ⁿ²pointsToRemove+Σ₀ⁿ¹⁺ⁿ²memoryAccess+n1*num_operations/points*cost/operations+others;

Where n1 is the number of points that need to be processed and kept, n2 is the number of points in the processing area that later need to be removed, operations refers to cost of the computation that is performed on each point, pointsToRemove is the cost to mask out or reset the area where the processing is not needed, memoryAccess refers to the cost of accessing data for each of the pixel being processed, others refers to the sum of possible overheads to start different computing device such as GPU and DSP. A point may be a pixel in an image or a voxel in a 3D structure. The performance model may be a learned cost function for different types of work items based on these features. For a work item with a given shape, this cost function may also require an additional step to remove/masking out unwanted pixels, which may add to the cost.

The cost may be measured by different targets, such as total time, the total energy consumption, etc. For example, the cost may refer to the total time or the speed of processing, assuming data parallelism in which processing of different region may be started at the same time independently on CPU/GPU/DSP. In such an example, the cost will the maximize processing time on the CPU, GPU or DSP for the regions for which each is responsible. This example may be represented by the following formula:

Total cost(processing time)=max(processing time on CPU,processing time on GPU,processing time on DSP)

As another example, the cost may refer to the total energy cost, in which case the total cost will be the sum of the energy cost on each of the three devices for processing the regions the it is responsible for. This example may be represented by the following formula:

Total cost(processing time)=energy consumption on CPU+energy consumption on GPU+energy consumption on DSP

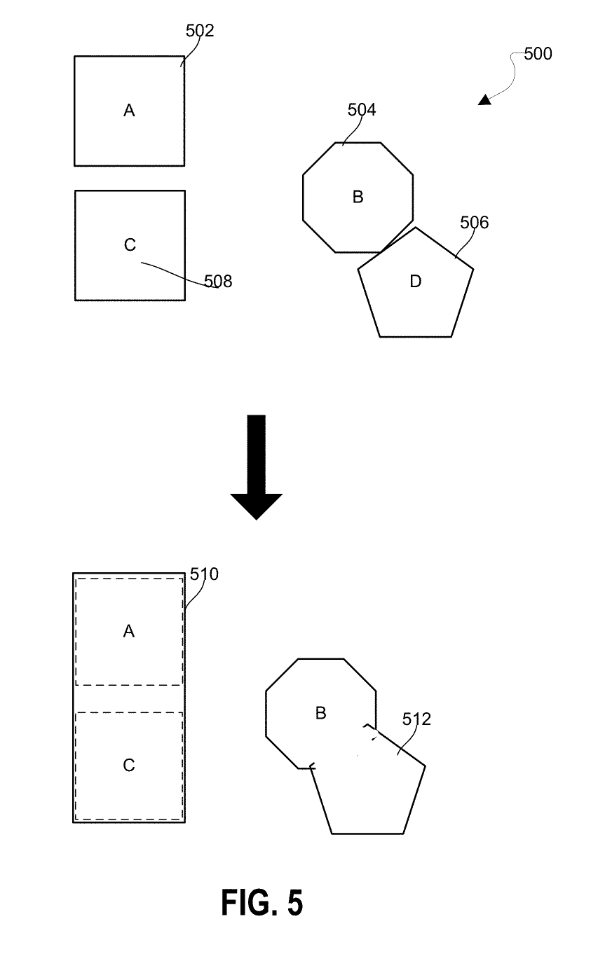

FIG. 5 illustrates merging strategies 500 that may be implemented by a computing device according to various embodiments. Various embodiments may include merging multiple smaller work regions by the processor (e.g., 110) of a computing device (e.g., 100) based on characteristics of each work region.

In various embodiments, the computing device may implement a merging strategy or a splitting strategy in whatever order it determines best suited for the work region. For example, if a captured work region is small, then merging the work region with a second work region may be preferable to beginning with a splitting strategy. As another example, if there is a large set of work items, each with a small number of pixels (e.g. <Nsmall), such as 502-508, then a merging strategy may be implemented prior to splitting. In various embodiments, a threshold pixel size or area of the region may be used to determine whether merging should be performed prior to splitting. For example, if the obtained work regions are smaller than a threshold size, merging may be implemented first.

The merging strategy may include implementing different clustering or grouping strategies, such as k-means or a bottom-up agglomerative clustering in which each work region starts in its own cluster and pairs of clusters are merged as one moves up the hierarchy. Proximity based clustering techniques are illustrated in FIG. 5, in which work regions 502 and 508 are merged to create a new, larger work region 510. Similarly, work regions 504 and 506, which are near to each other, are merged to create a new work region 512. Proximity based or spatial based clustering analysis may be well suited for efficient work processing prioritization because work regions near one another are likely to contain similar elements, such as parts of an image, and thus merging such regions may reduce redundant processing of similar elements.

In various embodiments, the computing device may estimate the cost function for a merged work region and may use the results as the merged resource cost. The merged resource cost may be compared to an unmerged resource cost, the cost function for processing all work regions individually and without merging, in order to determine whether to merge the work regions. If the unmerged resource cost is greater than the merged resource cost then the computing device may merge the work regions.

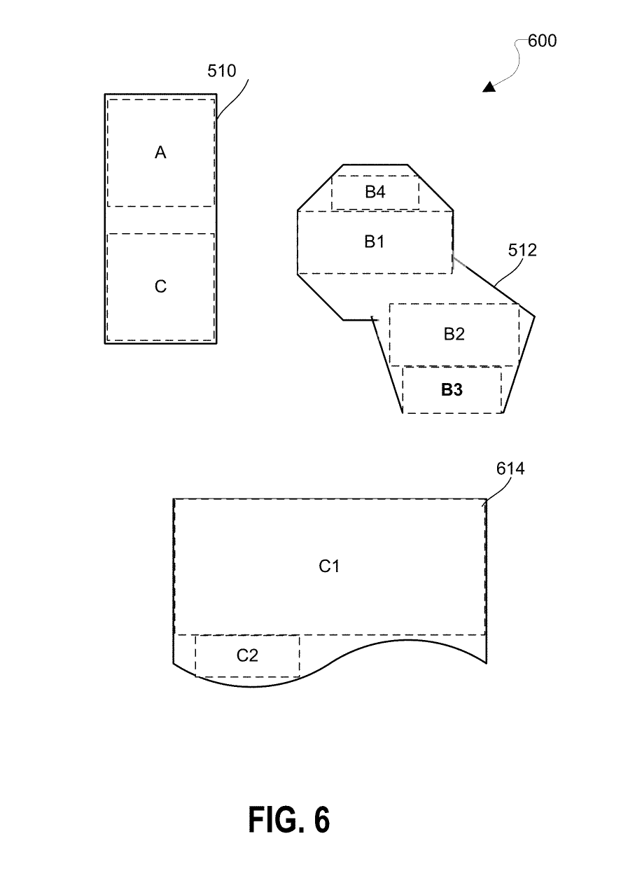

FIG. 6 illustrates a block diagram 600 of implementing splitting strategies according to various embodiments. Various embodiments may include splitting a work region into multiple smaller sections by the processor (e.g., 110) of a computing device (e.g., 100).

In various embodiments, the computing device may implement a splitting strategy prior to or after implementing a merging strategy. In the example illustrated in FIG. 6, the merged work regions 510 and 512 are subjected to a splitting strategy in order to further reduce the cost of executing the work regions and improve processing unit assignments. Work region 510 is rectangular and is large enough after merger to be processed efficiently by the GPU. Therefore, the work item (i.e., actual processing work) associated with work region 510 may be queued for processing by the GPU without requiring further modification. Conversely, work region 512 still has an irregular shape, which may be divided into smaller work region sections.

In various embodiments, the computing device may identify the largest regularly shaped section of the work region 512. The identified section may be horizontal or vertical. The computing device may continue this until all work region sections are identified, such as B1-B4. The computing device may then calculate cost functions for each of the work region sections B1-B4 as though they were independent work regions. The total cost of processing the work region sections may be a divided resource cost and may be compared to the cost of processing the work region 512 without splitting (i.e., undivided resource cost). If the divided resource cost is lower, then the computing device may split the identified working region sections away from the work region and queue those sections in appropriate processing unit queues.

Work region 614 may be a newly obtained work region with a size that exceeds the minimum threshold. Because the minimum threshold is exceeded, the work region 614 may be subjected to a splitting strategy prior to application of a merging strategy. Work region 614 may be split into a large work region section C1 and smaller work region section C2. The larger section may be well suited to processing by the GPU or DSP, while the smaller work region section C2 may be sent to the CPU for processing.

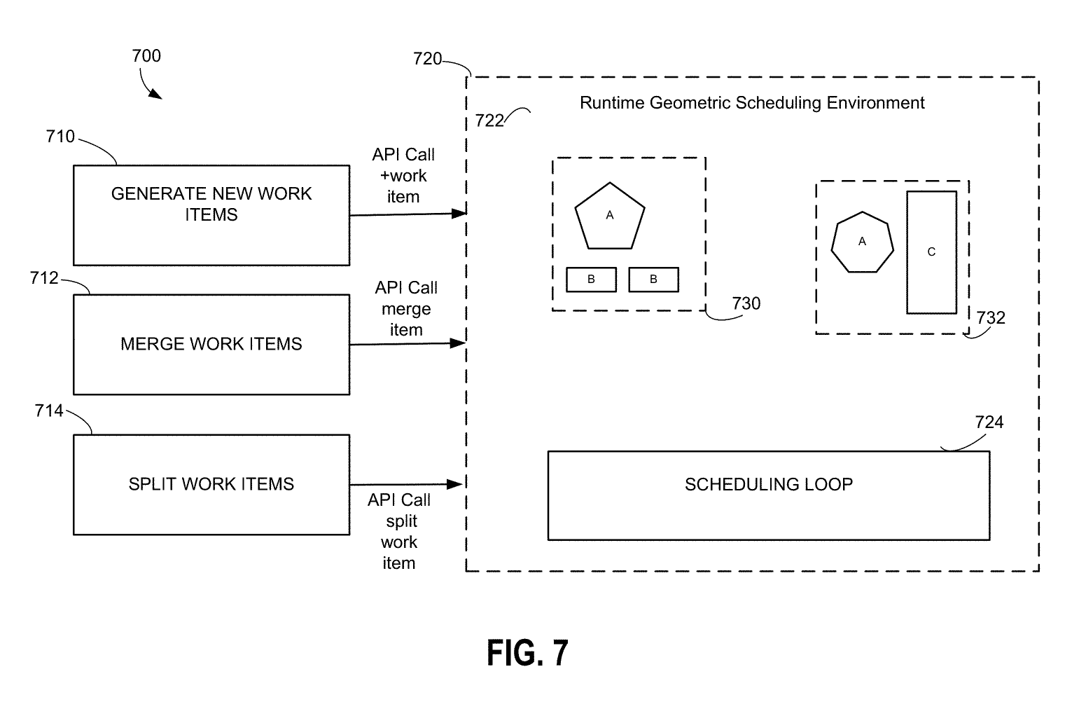

FIG. 7 is a functional block diagram of workflow through a runtime environment of a geometrically based work prioritization process according to various embodiments. The geometric work scheduling scheme 700 is shown having both a general environment 720 and application-specific operations 710, 712, 714. Various embodiments may include receiving or otherwise obtaining at a computing device (e.g., 100), an image frame, a video segment, a set of application API calls, or other processing work to be executed via one or more processors (e.g., 110).

In various implementations, the general environment 720 may control and maintain non-application specific-operations, and maintain data structures tracking information about identified work regions. For example, the general environment 720 may include a runtime geometric scheduling environment 722 that maintains data structures tracking identified work regions, as discussed with reference to FIGS. 4-6. Each of dotted line boxes 730 and 732 provide a visual representation of an obtained image frame, video segment, application call group, or other processing work set represented as a collection of work regions to be merged or split. Each dotted line box 730 732 may contain several component work regions. Various implementations may store this information in data structures. The geometric scheduling runtime environment may maintain and update these data structures as work items are added or completed. In various implementations, the general environment 720 may also manage the scheduling loop 724, which schedules individual work items for execution by one or more processors (e.g., 110).

In block 710, a processor (e.g., 110) of the computing device (e.g., 100) may generate new work items. As discussed with reference to FIGS. 4-6, the processor (e.g., 110) may generate new work items by obtaining or generating an image, video, group of API calls, or other processing work set; applying a boundary shape (e.g., a bounding box) to the obtained item, identify work regions falling within the boundary shape; determining a cost function for the work region, and determining whether to merge or split the work region based, at least in part on the cost function. The resultant work regions may be construed as work items. Each work item may further include the following information: the center of the work item within an N-dimensional space (i.e., the center of the associated work region); and the dimensions of the work item (i.e., the dimensions of the associated work region). The work item may optionally include information regarding a performance multiplier associated with execution of the work item on a specific processing unit (e.g., the GPU), and a power multiplier indicating an increased power efficiency based on execution on a specific processing unit. Further, the work item may include an application specific call-back function (e.g., discard operation) instructing the general environment 720 what to do in the event that a discard request is made for the work item.

At any time during runtime of a parent software application, the processor may generate new work items 710 and may make an API call such as a +work call to the general environment. The geometric scheduling runtime environment may receive the new work item and may store it in association with other work items belonging to the parent image, video segment, API call group, or other processing work set. In various embodiments, the geometric scheduling runtime environment may further maintain and track information regarding common elements across different images, video segments, API call groups, or other processing work sets, in order to form processing groups that may be sent to different processing units for efficient execution of like work items.

At any time during runtime of the software application, the processor may merge work regions 712. As discussed with reference to FIG. 7, the processor may merge, join, or otherwise combine regions of the image, video, API call group, etc., that are deemed to have common processing elements.

In block 714, the processor may split sections of work regions into standalone or new work regions. When new work items are generated, the dimension and position of a working boundary shape (e.g., bounding box) defining the common dimensions shared by related images, video segments, API call groups, etc. may be adjusted. As such, portions of an image or video segment that previously lay within the working boundary shape may no longer lie within the working boundary shape. For example, as the processor splits a work region into new sections there may no longer be a common, shared area across work regions.

In various embodiments, the processor may implement a scheduling loop 724 to execute processing of work items. The processor may reference an execution heap managed by the runtime geometric scheduling environment 722 and select the first work item in the execution work list to pull off the heap. As is discussed with reference to FIG. 7, the processor may execute a single work item on the managing processor, or may pull one or more work items off the heap for execution across multiple processing units (e.g., a CPU, a GPU, and a DSP). In implementations utilizing cross processor execution, the determination of work queues for each processing unit may be based on a work region characteristics for each work item. These characteristics may indicate the suitability of each work item to execution by a specific processing unit. Once a work item is completed, its status may be updated within the data structures maintained by the runtime geometric scheduling environment 722 to indicate that the work item processing is complete.

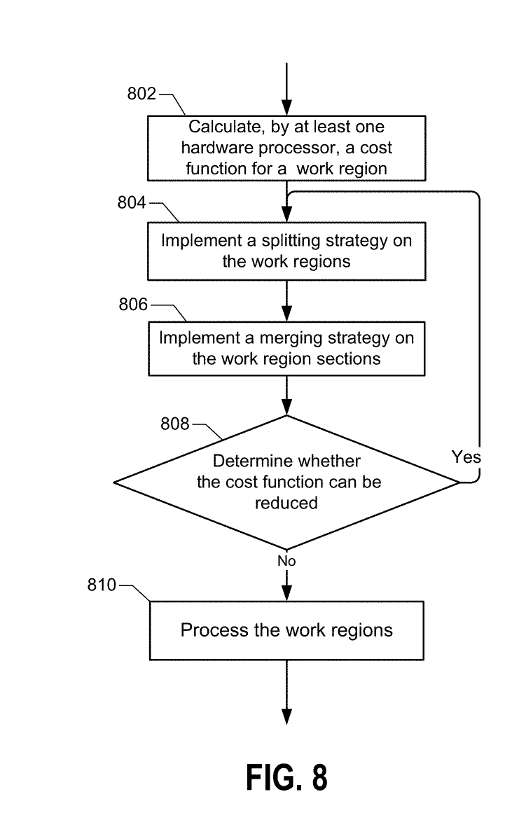

FIG. 8 illustrates a method 800 for geometrically based prioritization of work processing in various embodiments. The method 800 may be implemented on a computing device (e.g., 100) and carried out by at least one processor (e.g., 110) in communication with the communications subsystem (e.g., 130), and the memory (e.g., 125).

In block 802, the at least one processor of the computing device may calculate a cost function for a work region. The work region may be an image or other data set obtained, captured, or to be rendered by the computing device. The calculated cost function may provide a numerical indication regarding the suitability of the work region for processing on a processing unit of the computing device. Thus, there may be multiple cost functions for each work region, one cost function associated with each processing unit. In some embodiments, the cost function calculated for the work region may be used as a global cost function or “undivided” resource cost.

In some embodiments, the at least one processor may first determine whether the size of the work region exceeds a minimum threshold, and may select a modification strategy in response to determining that the size of the work region does or does not exceed the threshold. In other embodiments, the computing device may simply select a strategy and begin modification of the work region.

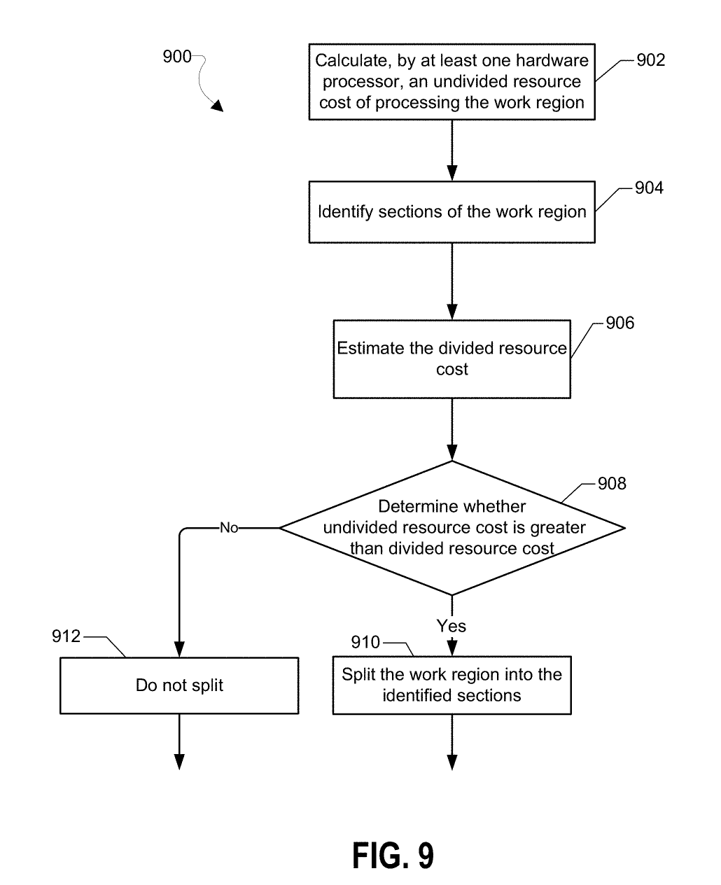

In block 804, the at least one processor may implement a splitting strategy on the work region based, at least in part, on the cost functions. The computing device may split the work region into multiple smaller, regularly shaped work region sections that are better suited to efficient processing on different processing units of the computing device. The implementation of a splitting strategy is described in detail with reference to FIG. 9 and method 900.

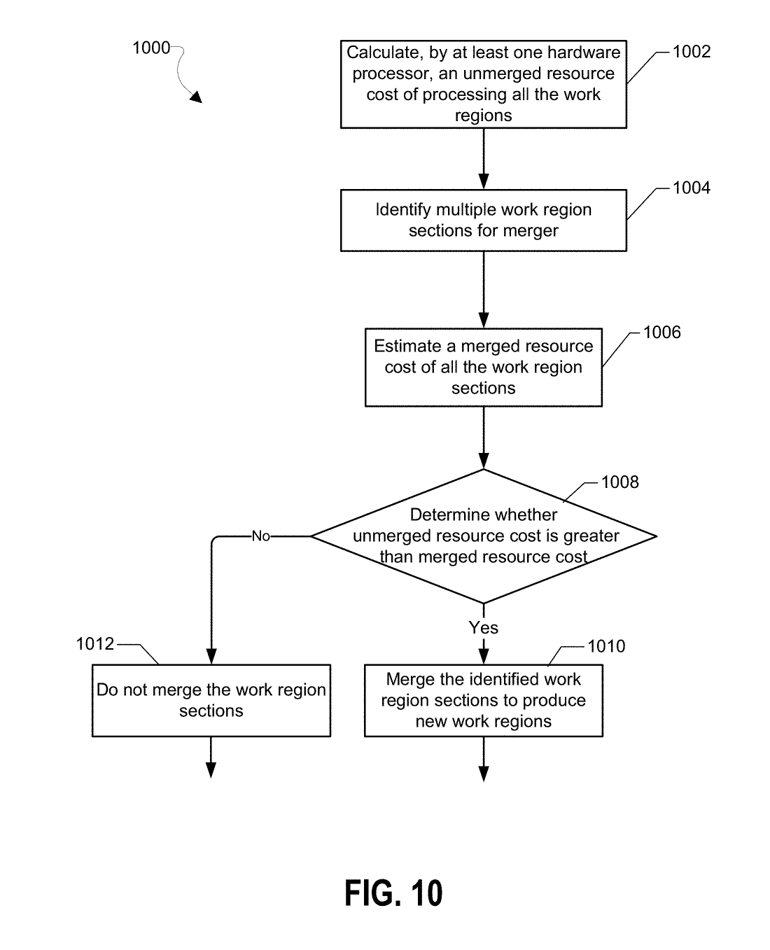

In block 806, the at least one processor may implement a merging strategy on the work regions based, at least in part, on the cost functions. If the work region sections are small, the computing device may attempt to merge some of the sections with similar or proximal work sections. The result of such mergers may be larger regularly shaped work regions that can be effectively processed by the GPU or DSP. The implementation of a merging strategy is described in detail with reference to FIG. 10 and method 1000.

In determination block 808, the at least one processor may determine whether the cost function can be reduced by the merger or splitting strategy. The computing device may calculate a global cost function for the split or merged work regions and assess whether further splitting or merging might reduce the global cost function. This may be an estimate made as a threshold determination of whether to engage in another round of splitting and merging.

In response to determining that the cost function can be reduced (i.e., determination block 808=“yes”), the at least one processor may return to or continue implementing a splitting strategy.

In response to determining that the cost function cannot be reduced (i.e., determination block 808=“No”), the at least one processor may in block 810, process the work regions. The at least one processor may queue each of the resulting work regions in an associated processing unit queue and commence processing of the work regions.

FIG. 9 illustrates an example method 900 for implementing a splitting strategy as in block 804 of the method 800. The method 900 may be implemented on a computing device (e.g., 100) and carried out by at least one processor (e.g., 110) in communication with the communications subsystem (e.g., 130) and the memory (e.g., 125).

In block 902, the at least one processor of the computing device may calculate an undivided resource cost of processing the work region. If this is the first implementation of the splitting strategy on the work region, then calculating the undivided resource cost may include using the cost function calculated for the work region. However, subsequent iterations of the splitting strategy may require the calculation of new cost a new undivided resource cost. For example, in circumstances in which a merged work region may be split into work region sections, an undivided resource cost may be calculated for the merged work region.

In block 904, the at least one processor may identify sections of a work region. For example, the at least one processor may utilize spatial algorithms to identify the largest regularly shaped sections lying within the boundaries of the work region. The at least one processor may then identify the next largest section of the work region and so on until all regions of a size or character suited to processing by the GPU or DSP have been identified. All remaining work region sections may be associated with the CPU for processing.

In block 906, the at least one processor may estimate a divided resource cost of the work region, based, at least in part on the identified sections. The at least one processor may calculate the cost function for each identified work region section and may sum these cost functions to obtain a divided resource cost. Therefore, the divided resource cost may represent the total cost of processing all of the work region sections if splitting is implemented.

In determination block 908, the at least one processor may determine whether the undivided resource cost is greater than the divided resource cost. The at least one processor may compare the value of the undivided resource cost function with the value of the divided resource cost function in order to determine which is greater.

In response to determining that the undivided resource cost is greater than the divided resource cost (i.e., determination block 908=“yes”), the at least one processor may split the identified sections to produce work region sections in block 910. In some cases, these work region sections may be sufficiently large that no further modification is needed. In some cases, smaller work region sections may be subjected to a merger strategy to create larger regularly shaped work regions. Some or all of the work region sections may be subjected to the merger strategy or alternatively removed from the modification process.

In response to determining that the undivided resource cost is less than the divided resource cost (i.e., determination block 908=“no”), the at least one processor may do nothing and allow the work regions to process without splitting the region into sections in block 912. The processor may subject the work region to a merger strategy or may send the associated work item to the appropriate processor (e.g., CPU, GPU, DSP, etc.) for task launch.

FIG. 10 illustrates a method 1000 for implementing a merging strategy as in block 806 of the method 800. The method 1000 may be implemented on a computing device (e.g., 100) and carried out by at least one processor (e.g., 110) in communication with the communications subsystem (e.g., 130), and the memory (e.g., 125).

In block 1002, the at least one processor may calculate an unmerged resource cost based at least in part on the cost functions, of processing all of the work region sections without merging. The at least one processor may determine the cost function for each work region section and/or work region. These cost functions may be summed to produce an unmerged resource cost.

In block 1004, the at least one processor may identify multiple work region sections for merger. In some embodiments, proximity based clustering of work regions may be used to identify work regions that may be merged. In some embodiments, k-means clustering may be used to identify work regions for merger based on the contents of the work region or its spatial characteristics.

In block 1006, the at least one processor may estimate a merged resource cost of all of the work region sections based, at least in part, on the identified work region sections. The at least one processor may calculate an estimated cost function for the potential result of a merger between two or more work region sections or work regions. The cost function may be summed with the cost function of any remaining unmerged work region sections or work regions to obtain the merged resource cost. In some embodiments, the unmerged and merged resource costs may account for only the cost functions of the work region sections or work regions that may be merged together (e.g., work regions 504 and 506 in FIG. 5).

In determination block 1008, the at least one processor may determine whether the unmerged resource cost is greater than the merged resource cost. The at least one processor may compare the value of the unmerged resource cost to that of the merged resource cost to determine which is greater.

In response to determining that the unmerged resource cost is greater than the merged resource cost, (i.e., determination block 1008=“Yes”), the at least one processor may merge the identified work region sections in block 1010. The processor may merge the two work region sections or work regions to produce a new work region. The new work region may be associated with a processing unit (e.g., a CPU, GPU, DSP, etc.) and queued for task launch, or may be subjected to a splitting strategy in order to further reduce the cost function of the work region.

In response to determining that the unmerged resource cost is less than the merged resource cost (i.e., determination block 1008=“no”), the at least one processor may do nothing and allow the work regions to continue on to the without merging work region sections in block 1012. The sections may be sent for processing by their assigned processing units.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a subscription and data receiving associated with a different subscription, such identifiers are merely for convenience and are not meant to limit various embodiments to a particular order, sequence, type of network or carrier.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, (e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of geometry based work scheduling on a computing device, comprising:
calculating, by at least one hardware processor of the computing device, a cost function for a work region;
implementing, by the at least one hardware processor, a splitting strategy on the work region to break the work region into a plurality of work region sections;
implementing, by the at least one hardware processor, a merging strategy on the plurality of work region sections;
determining, by the at least one hardware processor, whether the cost function can be reduced by splitting and merging the work region sections; and
processing, by multiple hardware processors of the computing device, the split and merged work region sections in response to determining that the cost function can to be reduced.

2. The method of claim 1, wherein implementing, by the at least one hardware processor, a splitting strategy on the work regions to break the work region into a plurality of work region sections comprises:
Identifying, by the at least one hardware processor, sections of the work region;
estimating, by the at least one hardware processor, a divided resource cost of the work region based on processing the identified sections;
determining, by the at least one hardware processor, whether the cost function for the work region is greater than the divided resource cost; and
splitting, by the at least one hardware processor, the identified sections from the work region to the plurality of produce work region sections in response to determining that the cost function for the work region is greater than the divided resource cost.

3. The method of claim 2, wherein estimating, by the at least one hardware processor, a divided resource cost of the work region based on processing the identified sections comprises:
calculating, by the at least one hardware processor, a splitting cost function for a work region section that would result from splitting an identified section away from the work region; and
estimating, by the at least one hardware processor, the divided resource cost of all of the cost functions associated with the work region including the split cost function.

4. The method of claim 2, wherein implementing, by the at least one hardware processor, a splitting strategy on the work regions to break the work region into a plurality of work region sections is repeated on the plurality of work region sections until there are no remaining sections for which the resulting divided resource cost is less than an undivided resource cost.

5. The method of claim 1, wherein implementing, by the at least one hardware processor, a merging strategy on the plurality of work region sections comprises:
calculating, by the at least one hardware processor, an unmerged resource cost based, at least in part, on cost functions of processing all of the plurality of work region sections without merging;
identifying, by the at least one hardware processor, multiple work region sections for merger;
estimating, by the at least one hardware processor, a merged resource cost of all of the work region sections;
determining, by the at least one hardware processor, whether the unmerged resource cost is greater than the merged resource cost; and
merging, by the at least one hardware processor, the identified work region sections in response to determine that the unmerged resource cost is greater than the merged resource cost.

6. The method of claim 5, wherein estimating, by the at least one hardware processor, the merged resource cost of all of the work region sections comprises:
calculating, by the at least one hardware processor, a merger cost function for a potential work region that would result from the merger of the identified work region sections; and
estimating, by the at least one hardware processor, the merged resource cost of all of the cost functions including the merged cost function.

7. The method of claim 5, wherein implementing, by the at least one hardware processor, a merging strategy on the plurality of work region sections is repeated until there are no remaining potential work region section mergers for which the resulting merged resource cost is less than the unmerged resource cost.

8. The method of claim 1, wherein the work regions are viewports of a virtual reality view space.

9. The method of claim 1, wherein the work regions are image frames to be combined into a panorama image.

10. The method of claim 1, wherein processing the split and merged work region sections comprises:
assigning, by the at least one hardware processor, the work region sections to the multiple hardware processors based, at least in part, on characteristics of the work regions; and
processing, by the multiple hardware processors, each of the work region sections on the assigned processing unit.

11. A computing device, comprising:
a memory; and
multiple hardware processors, at least one hardware processor being coupled to the memory and configured with processor-executable instructions to perform operations comprising:
calculating a cost function for a work region;
implementing a splitting strategy on the work region to break the work region into a plurality of work region sections;
implementing a merging strategy on the plurality of work region sections;
determining whether the cost function can be reduced by splitting and merging the work region sections; and
processing, by the multiple processors, the split and merged work region sections in response to determining that the cost function can to be reduced.

12. The computing device of claim 11, wherein the processor is further configured with processor-executable instructions to perform operations such that implementing a splitting strategy on the work regions to break the work region into a plurality of work region sections comprises:
identifying sections of the work region;
estimating a divided resource cost of the work region based on processing the identified sections;
determining whether the cost function for the work region is greater than the divided resource cost; and
splitting the identified sections from the work region to the plurality of produce work region sections in response to determining that the cost function for the work region is greater than the divided resource cost.

13. The computing device of claim 12, wherein the processor is further configured with processor-executable instructions to perform operations such that estimating a divided resource cost of the work region based on processing the identified sections comprises:
calculating a splitting cost function for a work region section that would result from splitting an identified section away from the work region; and
estimating the divided resource cost of all of the cost functions associated with the work region including the split cost function.

14. The computing device of claim 12, wherein the processor is further configured with processor-executable instructions to perform operations such that implementing a splitting strategy on the work regions to break the work region into a plurality of work region sections is repeated on the plurality of work region sections until there are no remaining sections for which the resulting divided resource cost is less than an undivided resource cost.

15. The computing device of claim 1, wherein the processor is further configured with processor-executable instructions to perform operations such that implementing a merging strategy on the plurality of work region sections comprises:
calculating an unmerged resource cost based, at least in part, on cost functions of processing all of the plurality of work region sections without merging;
identifying multiple work region sections for merger;
estimating a merged resource cost of all of the work region sections;
determining whether the unmerged resource cost is greater than the merged resource cost; and
merging the identified work region sections in response to determine that the unmerged resource cost is greater than the merged resource cost.

16. The computing device of claim 15, wherein the processor is further configured with processor-executable instructions to perform operations such that estimating the merged resource cost of all of the work region sections comprises:
calculating a merger cost function for a potential work region that would result from the merger of the identified work region sections; and
estimating the merged resource cost of all of the cost functions including the merged cost function.

17. The computing device of claim 15, wherein the processor is further configured with processor-executable instructions to perform operations such that implementing a merging strategy on the plurality of work region sections is repeated until there are no remaining potential work region section mergers for which the resulting merged resource cost is less than the unmerged resource cost.

18. The computing device of claim 11, wherein the processor is further configured with processor-executable instructions to perform operations such that the work regions are one of viewports of a virtual reality view space or image frames to be combined into a panorama image.

19. The computing device of claim 11, wherein the processor is further configured with processor-executable instructions to perform operations such that processing the split and merged work region sections comprises:
assigning the work region sections to the multiple hardware processors based, at least in part, on characteristics of the work regions; and
processing, by the multiple hardware processors, each of the work region sections on the assigned processing unit.

20. A non-transitory processor-readable medium on which are stored processor-executable instructions configured to cause a processor to perform operations comprising:
calculating a cost function for a work region;
implementing a splitting strategy on the work region to break the work region into a plurality of work region sections;
implementing a merging strategy on the plurality of work region sections;
determining whether the cost function can be reduced by splitting and merging the work region sections; and
processing the split and merged work region sections in response to determining that the cost function can to be reduced.
